(19) United States
(12) Patent Application Publication
(10) Pub. No.: US 2025/0368886 A1
(43) Pub. Date: Dec. 4, 2025

(54) MITIGATING IRON SULFIDE IN GAS WELLS

(71) Applicant: Halliburton Energy Services, Inc., Houston, TX (US)

(72) Inventors: Christopher John Holp, Houston, TX (US); Zhiwei Yue, Houston, TX (US); Nathan Darrell Davis, Houston, TX (US); Chunli Li, Houston, TX (US)

(73) Assignee: Halliburton Energy Services, Inc., Houston, TX (US)

(21) Appl. No.: 18/675,319

(22) Filed: May 28, 2024

(51) Int. Cl. C09K 8/532; C09K 8/54

(52) U.S. Cl. CPC C09K 8/532; C09K 8/54; C09K 2208/32

(57) ABSTRACT

A method may include introducing a metal sulfide mitigation package comprising a hydroxysultaine dispersing agent, a water-wetting surfactant, and a corrosion inhibitor into a wellbore; contacting a metal sulfide scale in the wellbore with the metal sulfide mitigation package; and dissolving at least a portion of the metal sulfide scale with the metal sulfide mitigation package.

### BACKGROUND

In the oilfield, scale deposits can represent a particular issue during various subterranean operations including drilling, casing, primary cementing, remedial cementing, hydraulic fracturing, gravel packing, frac-packing, solids control, wellbore and well remediation, swabbing, chemical injection, chemical flooding for enhanced oil recovery, steam injection, production enhancement, and production of oil and gas, among other wellbore operations. Scale can decrease the permeability of a subterranean formation, reduce well productivity, and shorten the lifetime of production equipment. Scale is a solid that precipitates out of solution or accumulates on the surface of subterranean materials, such as in fractures or subterranean flow pathways, or on equipment downhole, such as production tubing, gravel packing screens, or on equipment above the surface. Scale is a mineral or solid that is formed due to scale-forming ions that are present in water or petroleum downhole, such as Fe²⁺, Ca²⁺, Mg²⁺, Sr²⁺, and Ba²⁺. Examples of scale include carbonate salts, sulfate salts, or sulfide salts, such as CaCO₃, BaSO₄, SrSO₄, CaSO₄, and FeS. Cleaning and removal of scale generally requires stopping production and is both time-consuming and costly. Scale control challenges are a leading cause of declining production worldwide. Scale costs the petroleum industry millions of dollars each year in scale control and removal costs, and in deferred production.

The deposition of iron sulfide (FeS) scale inside production systems is a persistent problem in the production of oil and gas. Preventing FeS deposits presents a significant challenge, particularly when addressing downhole FeS in high temperature gas wells. Acid containing fluids can be used to remove FeS scale but present health, safety, and environmental concerns. Additionally, acid interventions have elevated corrosion risks when used in wells at relatively higher temperatures. Chelating agent containing fluids, such as fluids containing tetrakis(hydroxymethyl)phosphonium sulfate, can also be used to treat FeS but the chelating agent typically requires a high dosage and long shut-in time to be effective, leading to higher treatment cost and deferred production. Additionally, certain chelating agents may cause irreversible scaling in barium-rich wells.

### BRIEF DESCRIPTION OF THE DRAWINGS

These drawings illustrate certain aspects of some of the embodiments of the present disclosure and should not be used to limit or define the disclosure.

FIG. 1 is a schematic illustration of a fluid handling system for preparation and delivery of a treatment fluid comprising a metal sulfide mitigation package into a wellbore in accordance with some embodiments of the present disclosure.

FIG. 2 is a schematic illustration of a well system for introduction of the treatment fluid comprising a metal sulfide mitigation package into a wellbore in accordance with some embodiments of the present disclosure.

FIG. 3 is a schematic illustration of a well system for introduction of the treatment fluid comprising a metal sulfide mitigation package into a wellbore in accordance with some embodiments of the present disclosure.

FIG. 4 is a graph of gas production and well casing pressure for a wellbore treated with a treatment fluid comprising a metal sulfide mitigation package in accordance with some embodiments of the present disclosure.

### DETAILED DESCRIPTION

Disclosed herein are methods and compositions for scale removal and, more particularly disclosed are methods and compositions for scale removal using a metal sulfide mitigation package which includes a hydroxysultaine dispersing agent, corrosion inhibitor, and a water-wetting surfactant. The metal sulfide mitigation package is effective to remove metal sulfide scale from downhole equipment such as production tubing and gravel packing screens as well as from surface equipment. In some embodiments, the metal sulfide mitigation package is introduced as a pill to treat metal sulfide scale deposited in the wellbore. In further embodiments, metal sulfide mitigation package is introduced continuously and/or intermittently to mitigate metal sulfide scale from depositing.

In embodiments, the metal sulfide mitigation package includes a hydroxysultaine dispersing agent, corrosion inhibitor, and a water-wetting surfactant.

The hydroxysultaine dispersing agent exhibits molecular interactions with dissolved and/or precipitated iron and iron sulfide particles and can inhibit formation of FeS or disperse FeS particles once formed. Without being limited by theory, it is believed that the hydroxysultaine dispersing agent may adsorb FeS particles with negative surfaces charges which in turn can prevent the FeS particles from flocculating. In embodiments, the hydroxysultaine dispersing agent has a chemical structure according to Structure 1 below:

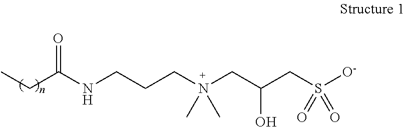

where n is the number of repeat carbon units (—CH₂—). In embodiments, n is 6, 8, 10, 12, 14, or 16. In embodiments the metal sulfide mitigation package includes a combination of hydroxysultaine dispersing agents with differing numbers of repeat carbon units. In embodiments, the hydroxysultaine dispersing agent is present in the metal sulfide mitigation package in an amount at a point in a range of 25 vol. % to 75 vol. %. Alternatively, in an amount at a point in a range of 25 vol. % to 50 vol. %, in an amount at a point in a range of 50 vol. % to 75 vol. %, in an amount at a point in a range of 35 vol. % to 65 vol. %, or any ranges therebetween, or in an amount at a point in a range of any subranges therebetween.

In embodiments, the water-wetting surfactant includes a nonylphenol ethoxylate with the generalized chemical structure according to Structure 2 below:

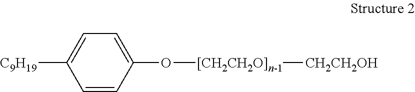

In embodiments, n is the number of ethyl oxide units. In embodiments, n is 6, 8, 10, 12, 14, 16, or 18.

In further embodiments, the metal sulfide mitigation package includes water-wetting surfactants such as alcohol ethoxylates, alcohol ethoxy sulfates, alkyl phenol ethoxylates (e.g., nonyl phenol ethoxylates), glycol ethers, and combinations thereof. Certain water-wetting surfactants may be used as water-soluble salts. For example, the water-wetting surfactants may be selected from alkali metal, alkaline earth metal, ammonium, and alkanol ammonium salts of alcohol ethoxylates, alcohol ethoxy sulfates, and alkyl phenol ethoxylates.

Examples of suitable alcohol ethoxylates include C₆ to C₁₆ alcohols substituted with from about 2 moles to about 15 moles and, alternatively, from about 5 moles to about 12 moles of ethylene oxide. The C₆ to C₁₅ alcohols may be linear or branched. Examples of suitable alcohol ethoxylates may include C₄ to C₈ alcohols substituted with about 4 moles to about 8 moles of ethylene oxide, C₈ to C₁₂ alcohols substituted with about 4 moles to about 8 moles of ethylene oxide, and C₁₂ to C₁₄ alcohols substituted with about 10 moles to about 14 moles of ethylene oxide. Specific examples of suitable alcohol ethoxylates may include butanol, hexanol or pentanol substituted with 6 moles of ethylene oxide, nonyl, decyl alcohol, or dodecyl alcohol substituted with 6 moles of ethylene oxide, or dodecyl alcohol, tridecyl alcohol, or tetradecyl alcohol substituted with 12 moles of ethylene oxide. Additional examples of suitable alcohol ethoxylates may include isodecyl alcohol substituted with 6 moles of ethylene oxide or isotridecyl alcohol substituted with 12 moles ethylene oxide. Combinations of suitable alcohol ethoxylates may also be used.

Examples of suitable alcohol ethoxy sulfates may include C₁₀ to C₁₆ alcohols substituted with about 2 moles to about 15 moles of ethylene oxide. The C₁₀ to C₁₆ alcohols may be linear or branched. Suitable C₁₀ to C₁₆ alcohol ethoxylates may include docecyl alcohol, tridecyl alcohol, or tetradecyl alcohol substituted with from 2 moles to about 15 moles and, alternatively from about 6 moles to about 12 moles of ethylene oxide. Additional examples of suitable alcohol ethoxylates may include ethoxylated dodecyl alcohol ammonium sulfate or ethoxylated tetradecyl ammonium sulfate. Combinations of suitable alcohol ethoxy sulfates may also be used.

Examples suitable alkyl phenol ethoxylates may include an alkyl group with from 1 to 12 carbon atoms and, alternatively, from about 8 to 12 carbon atoms. The alkyl phenol ethoxylates may have from 2 moles to about 18 moles of ethylene oxide and, alternatively, from about 8 moles to about 12 moles of ethylene oxide. One example of a suitable alkyl phenol ethoxylate is nonyl phenol ethoxylate having from about 8 moles to about 12 moles of ethylene oxide and, alternatively, about 10 moles of ethylene oxide.

Examples of suitable glycol ethers may include an alkyl ether of a mono-, di-, or triethylene glycol. The alkyl ether may include a C₁ to C₅ alkyl ether of a mono-, di-, or triethylene glycol. By way of example, the glycol ether may include diethylene glycol methyl ether, dipropylene glycol methyl ether, 2-butoxy ethanol, ethers of a C₂ to C₆ dihydric alkanol that comprise at least one C₁ to C₆ alkyl group, mono ethers of dihydric alkanols, methoxy propanol, butoxyethanol, hexoxyethanol, isomers thereof, and combinations thereof. One example of a suitable glycol ether may comprise ethylene glycol monobutyl ether. The glycol ethers may be used by themselves in the solid surfactant composite or as a co-surfactant with one or more of the additional water-wetting surfactants described herein. Without limitation, a glycol ether such as ethylene glycol monobutyl ether may be used as a co-surfactant (50% to 90% by weight) with an alcohol ethoxylates, such as butanol, hexanol or pentanol substituted with from 4 moles to about 8 moles and, alternatively, about 6 moles of ethylene oxide.

In embodiments, the water-wetting surfactant is present in the metal sulfide mitigation package in an amount at a point in a range of 1 vol. % to 25 vol. %. Alternatively, in an amount at a point in a range of 1 vol. % to 10 vol. %, in an amount at a point in a range of 10 vol. % to 20 vol. %, in an amount at a point in a range of 20 vol. % to 30 vol. %, or in an amount at a point in a range of any subranges therebetween.

In embodiments, the metal sulfide mitigation package includes a corrosion inhibitor comprising a benzalkonium chloride with the generalized chemical structure according to Structure 3 below:

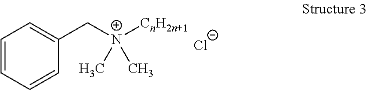

In embodiments, n is selected from 8, 10, 12, 14, 16, or 18. In embodiments where benzalkonium chloride is included in the metal sulfide mitigation package, the benzalkonium chloride is present in the metal sulfide mitigation package in an amount at a point in a range of 0.1 vol. % to 3.0 vol. %. Alternatively, in an amount at a point in a range of 0.1 vol. % to 0.3 vol. %, in an amount at a point in a range of 0.3 vol. % to 0.5 vol. %, in an amount at a point in a range of 0.5 vol. % to1.0 vol. %,.in an amount at a point in a range of 1.0 vol. % to 2.0 vol. %, in an amount at a point in a range of 2.0 vol. % to 3.0 vol. %, or in an amount at a point in a range of any subranges therebetween.

In embodiments, the metal sulfide mitigation package includes a corrosion inhibitor comprising a thioglycolic acid with the generalized chemical structure according to Structure 4 below:

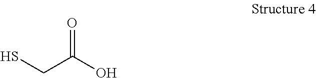

In embodiments where thioglycolic acid is included in the metal sulfide mitigation package, the thioglycolic acid is present in the metal sulfide mitigation package in an amount at a point in a range of 0.1 vol. % to 3.0 vol. %. Alternatively, in an amount at a point in a range of 0.1 vol. % to 0.3 vol. %, in an amount at a point in a range of 0.3 vol. % to 0.5 vol. %, in an amount at a point in a range of 0.5 vol. % to 1.0 vol. %, in an amount at a point in a range of 1.0 vol. % to 2.0 vol. %, in an amount at a point in a range of 2.0 vol. % to 3.0 vol. %, or in an amount at a point in a range of any subranges therebetween.

In embodiments, the metal sulfide mitigation package includes a corrosion inhibitor comprising an imidazoline such as soy/DETA imidazoline with the chemical structure according to Structure 5 below.

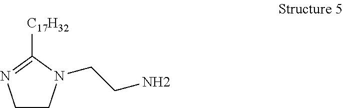

In further embodiments, the metal sulfide mitigation package includes a corrosion inhibitor comprising an imidazoline comprising the general chemical structure of Structure of structure 6 below.

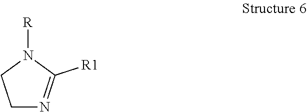

In Structure 6. R is selected from TEPA (Structure 7), TETA (Structure 8), DETA (Structure 9), AEEA (Structure 10), or polyethylene diamine (Structure 11) where n is from 1 to 100.

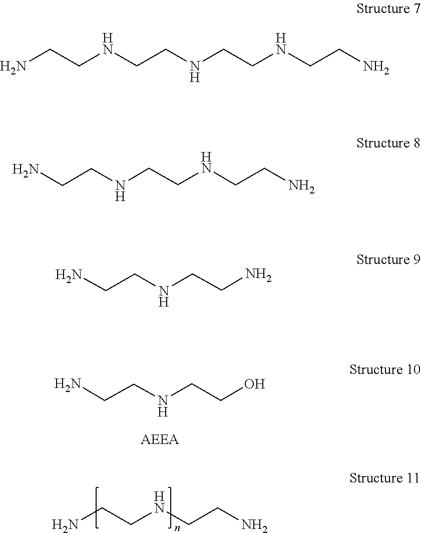

In Structure 6, R1 is selected from straight alkyl, unsaturated alkenyl, di unsaturated alkenyl, tri unsaturated alkenyl, oligo unsaturated alkyl, branched alkyl and cyclic alkyl. In embodiments, R1 has a carbon chain length at a point in a range of 7 to 21. In embodiments, R1 is the carbon chain of an acid or ester compound. In embodiments, the acid or ester compound is at least one of tall oil fatty acid (TOFA), coconut oil, tallow fatty acid (tallow), naphthenic acids, soy fatty acid (soy), oleic acid. In embodiments, suitable imidazolines include 1:1 (molar ratio) TOFA/DETA imidazoline, 2:1 TOFA/DETA amido imidazoline, 1:1 TOFA/TETA imidazoline, 2:1 TOFA/TETA amido-imidazoline, 2:1 TOFA/TETA bisimidazoline, 1:1 TOFA/TEPA imidazoline, 2:1 TOFA/TEPA amido imidazoline, 2:1 TOFA/TEPA bis imidazoline, 3:1 TOFA/TEPA amido bisimidazoline, 1:1 TOFA/AEEA imidazoline, 2:1 TOFA/AEEA amido imidazoline, 1:1 TOFA/polyamine imidazoline, 2:1 TOFA/polyamine imidazoline, 2:1 TOFA/polyamine amido imidazoline, 2:1 TOFA/polyamine bisimidazoline, 3:1 TOFA/TEPA polyamine amido bisimidazoline, 1:1 Soy/DETA imidazoline, 2:1 Soy/DETA amido-imidazoline, 1:1 Soy/TETA imidazoline, 2:1 Soy/TETA amido-imidazoline, 2:1 Soy/TETA bismidazoline, 1:1 Soy/TEPA imidazoline, 2:1 Soy/TEPA amido imidazoline, 2:1 Soy/TEPA bisimidazoline, 3:1 TOFA/TEPA amido bisimidazoline, 1:1 Soy/AEEA imidazoline, 2:1 Soy/AEEA amidoimidazoline, 1:1 Soy/polyamine imidazoline, 2:1 Soy/polyamine imidazoline, 2:1 Soy/polyamine amido imidazoline, 2:1 Soy/polyamine bisimidazoline, 1:1 Tallow/DETA imidazoline, 2:1 Tallow/DETA amido-imidazoline, 1:1 Tallow/TETA imidazoline, 2:1 Tallow/TETA amido-imidazoline,2:1 Tallow/TETA bismidazoline, 1:1 Tallow/TEPA imidazoline, 2:1 Tallow/TEPA amido imidazoline, 2:1 Tallow/TEPA bisimidazoline, 3:1 Tallow/TEPA amido bisimidazoline, 1:1 Tallow/AEEA imidazoline, 2:1 Tallow/AEEA amidoimidazoline, 1:1 Tallow/polyamine imidazoline, 2:1 Tallow/polyamine imidazoline, 2:1 Tallow/polyamine amido imidazoline, 2:1 Tallow/polyamine bisimidazoline, 3:1 Tallow/TEPA poly amine amido bisimidazoline, and combinations thereof.

In embodiments where imidazoline corrosion inhibitor is included in the metal sulfide mitigation package, the imidazoline corrosion inhibitor is present in the metal sulfide mitigation package in an amount at a point in a range of 1 vol. % to 10 vol. %. Alternatively, in an amount at a point in a range of 1 vol. % to 3 vol. %, in an amount at a point in a range of 3 vol. % to 6 vol. %. in an amount at a point in a range of 6 vol. % to 10 vol. %, or in an amount at a point in a range of any subranges therebetween.

In further embodiments, the metal sulfide mitigation package additionally includes a corrosion inhibitor comprising a phosphonate scale inhibitor comprising the general chemical structure of Structure of Structure 12 below. Structure 12 is aminoethylethanolamine phosphonate.

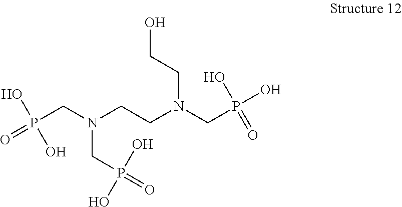 [SMILES: O=P(O)(O)CN(CCO)CCN(CP(=O)(O)O)CP(=O)(O)O]

In embodiments where phosphonate scale inhibitor is included in the metal sulfide mitigation package, the phosphonate scale inhibitor is present in the metal sulfide mitigation package in an amount at a point in a range of 5 vol. % to 20 vol. %. Alternatively, in an amount at a point in a range of 5 vol. % to 10 vol. %, in an amount at a point in a range of 10 vol. % to 15 vol. %. in an amount at a point in a range of 15 vol. % to 20 vol. %, or in an amount at a point in a range of any subranges therebetween.

In further embodiments, the metal sulfide metal sulfide mitigation package further includes a solvent and/or a mutual solvent.

In embodiments, the metal sulfide metal sulfide mitigation package includes a petroleum oil, natural oil, synthetically-derived oil, mineral oil, base oil that is used to make oil-based drilling fluids, terpenes, such as d-limonene, hydrocarbons, or combinations thereof. The oleaginous fluids may be included in the metal sulfide mitigation package in an amount at a point in a range of 5 vol. % to about 50 vol. %. Alternatively, in an amount at a point in a range of 5 vol. % to about 15 vol. %, in an amount at a point in a range of 15 vol. % to about 25 vol. %, in an amount at a point in a range of 25 vol. % to about 50 vol. %, or in an amount at a point in a range of any subranges therebetween.

In one or more embodiments, the metal sulfide metal sulfide mitigation package includes at least one solvent. Nonlimiting examples of solvents suitable for use in the metal sulfide mitigation package include butyl alcohol, pentanol, branched and linear hexanol, 2-ethylhexanol, 1-heptanol, 2-heptanol, octanol, C₆ to C₁₃ alkyl alcohols, diols, n-butyl lactate, isobutyl lactate, 2,2,4-trimethyl-1,3-pentanediol monoisobutyrate, butyl 2-hydroxybutyrate, methanol, ethanol, n-propanol, isopropanol, n-butanol, sec-butanol, isobutanol, and t-butanol), glycerins, glycols (e.g., polyglycols, propylene glycol, and ethylene glycol), polyglycol amines, polyols, fresh water, saltwater (e.g., water containing one or more salts dissolved therein), brine (e.g., saturated salt water), seawater, produced water, wastewater, and any combination thereof.

In one or more embodiments, the metal sulfide metal sulfide mitigation package includes at least one mutual solvent. In one or more embodiments, the mutual solvent includes methanol, ethanol, n-propanol, isopropyl alcohol (IPA), butyl alcohol, methyl glycolate, ethyl glycolate, n-propyl glycolate, isopropyl glycolate, methyl lactate, ethyl lactate, n-propyl lactate, isopropyl lactate, ethylene glycol monobutyl ether, diethylene glycol monobutyl ether, triethylene glycol monobutyl ether, propylene glycol monobutyl ether (PGMBE), dipropylene glycol monobutyl ether, tripropylene monobutyl ether, diethylene glycol monoethyl ether, dipropylene glycol monomethyl ether, butylcarbitol, ethers or esters of glycols, glycerol, polyglycerol, polyols, derivatives thereof or, a combination thereof.

In embodiments where a solvent and/or a mutual solvent, individually or in combination, is included in the metal sulfide mitigation package, in an amount at a point in a range of 5 vol. % to 50 vol. %. Alternatively, in an amount at a point in a range of 5 vol. % to 15 vol. %, in an amount at a point in a range of 15 vol. % to 30 vol. %. in an amount at a point in a range of 30 vol. % to 50 vol. %, or in an amount at a point in a range of any subranges therebetween.

The metal sulfide mitigation package may be introduced as a treatment fluid for removal of the metal sulfide scale in any suitable operation at any suitable stage of the wellbore's life, which includes well drilling and production. In embodiments, the metal sulfide treatment can be an iron sulfide mitigation package. The treatment fluid may be introduced into the wellbore and may remove any form of iron sulfide scale from any surface along the wellbore and associated processing equipment by making fluidic contact. The treatment fluid may then penetrate the pores of the iron sulfide scale structure and may disintegrate the iron sulfide scale which is then carried to the surface and produced.

The deposition of iron sulfide particles on the internal surfaces of a wellbore including pipelines and associated process equipment lead to scale buildup. Iron sulfide scales may be deposited in layers along a tubular such that a sample of scale may include several forms of iron sulfide within a section of scale. The disparate chemistry of the layers of iron sulfide may preclude dissolution of the iron sulfide scale by mineral acid alone, or organic acid alone, or chelating agent alone. Iron sulfide scale may exist in six different types and mixtures of said types which may include: purrhotite (Fe₇S₈), troilite (FeS), marcasite (FeS₂), pyrite (FeS₂), greigite (Fe₂S₄), and mackinawite (Fe₉S₈). Partially due to the sulfur, iron sulfide scales may be hydrophobic on their surfaces, and may be coated with oil in the oleaginous wellbore environment. Iron sulfide scales range from having a well-defined crystalline structure to amorphous species. Physical properties of the iron sulfide scale range from viscous gels to powders to fluffy crystals. Morphology of the iron sulfide scale may vary from needle-like structures to granular particles. The physical structure of the iron sulfide scale may be dependent upon the chemical identity of iron sulfide as well as the conditions which the iron sulfide formed, for example. Additional components of the iron sulfide scale may include heteroatoms such as carbon, oxygen, chlorine, calcium, and combinations thereof in varying weight percentages.

In embodiments where the metal sulfide metal sulfide mitigation package is introduced as a fluid pill to treat scale, the metal sulfide metal sulfide mitigation package can be introduced into the wellbore in an amount of 1 bbl to 200 bbl or more for treatment of the scale. In embodiments where the metal sulfide metal sulfide mitigation package is introduced as a continuous or intermittent treatment, the metal sulfide metal sulfide mitigation package can be introduced through an annulus drip, a slip stream, a capillary string, or batch treatments. The annulus drip technique may include introduction of the metal sulfide metal sulfide mitigation package into the wellbore at the wellhead in the annulus between the production tubing and production casing. The metal sulfide metal sulfide mitigation package may then fall (or drip) to the bottom of the wellbore whereby contact may be made with wellbore fluids and cause the wellbore fluids to foam to a foamed mixture. The foamed mixture may be produced back up through the production tubing where the foaming agent may contact downhole equipment and provide iron sulfide mitigation. The slip stream technique may include application of the metal sulfide metal sulfide mitigation package into a slip stream of produced wellbore fluids that may be introduced into the annulus between the production tubing and production casing. The metal sulfide metal sulfide mitigation package may then fall (or drip) to the bottom of the wellbore and be produced back up through the production tubing where it may contact downhole equipment. A valve may be used in the regulation the volume of the metal sulfide metal sulfide mitigation package into the slip stream. The capillary stream technique may include introduction of the metal sulfide metal sulfide mitigation package into the wellbore through a capillary tube that extends down the annulus to the bottom of the wellbore. The capillary tube may be a small diameter tube, for example, about ¼ inches (0.6 cm) to about ⅜ inches (0.95 cm) in outer diameter. The batch technique may include pumping a large volume of the metal sulfide metal sulfide mitigation package into the annulus. A pump truck or other suitable pump may be used to displace the metal sulfide metal sulfide mitigation package to the bottom of the wellbore. By introducing a large volume, residual concentrations of metal sulfide metal sulfide mitigation package may continue to provide FeS mitigation even after treatment. In embodiments, the metal sulfide metal sulfide mitigation package is introduced such that a concentration of the metal sulfide metal sulfide mitigation package at a downhole location is in an amount at a point in a range of 250 ppm to 5000 ppm. Alternatively, the metal sulfide metal sulfide mitigation package is introduced such that a concentration of the metal sulfide metal sulfide mitigation package at a downhole location is in an amount at a point in a range of 250 ppm to 500 ppm, in an amount at a point in a range of 500 ppm to 750 ppm, in an amount at a point in a range of 750 ppm to 1000 ppm, in an amount at a point in a range of 1000 ppm to 2000 ppm, in an amount at a point in a range of 2000 ppm to 5000 ppm, or in an amount at a point in a range of any subranges therebetween.

In embodiments, the metal sulfide mitigation package is introduced into a wellbore having an elevated temperature such as a bottom hole static temperature in a range of 275° F. to 400° F. or greater.

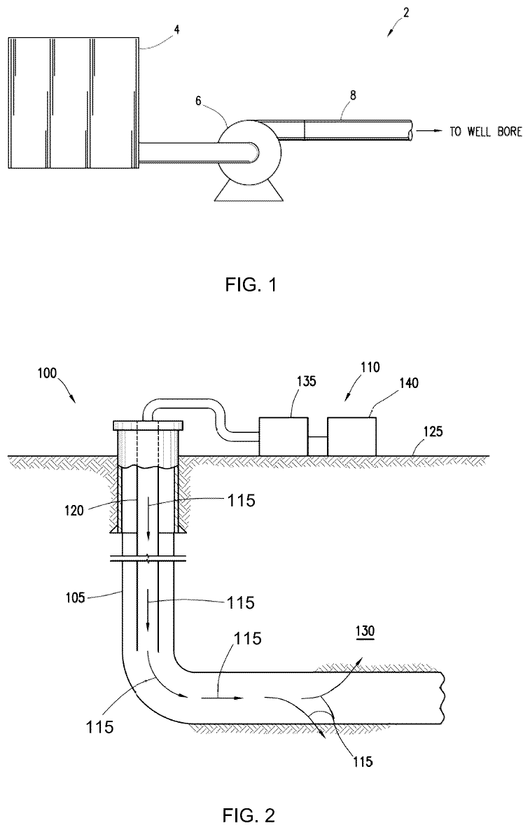

FIG. 1 is a schematic illustration of a fluid handling system 2 for preparation and delivery of a treatment fluid comprising a metal sulfide mitigation package into a wellbore according to an embodiment of the present disclosure. The fluid handling system 2 may be used for preparing the metal sulfide mitigation package and introducing it into a wellbore. The fluid handling system 2 may include mobile vehicles, immobile installations, skids, hoses, tubes, fluid tanks or reservoirs, pumps, valves, and/or other suitable structures and equipment. For example, the fluid handling system 2 may include a fluid supply 4 and pumping equipment 6, which both may be fluidically coupled with a wellbore supply conduit 8. The fluid supply 4 may contain the treatment fluid comprising the metal sulfide mitigation package. The pumping equipment 6 may be used to supply the treatment fluid comprising a metal sulfide mitigation package from the fluid supply 4, which may include tank, reservoir, connections to external fluid supplies, and/or other suitable structures and equipment. While not illustrated, the fluid supply 4 may contain one or more components of the treatment fluid comprising a metal sulfide mitigation package and a base fluid in separate tanks or other containers that may be mixed at any desired time. Pumping equipment 6 may be fluidically coupled with the wellbore supply conduit 8 to communicate the treatment fluid comprising a metal sulfide mitigation package into wellbore. Fluid handling system 2 may also include surface and down-hole sensors to measure pressure, rate, temperature and/or other parameters of the treatment fluid. Fluid handling system 2 may include pump controls and/or other types of controls for starting, stopping and/or otherwise controlling pumping as well as controls for selecting and/or otherwise controlling fluids pumped during the injection treatment. An injection control system may communicate with such equipment to monitor and control the injection treatment. Fluid handling system 2 can be configured as shown in FIG. 1 or in a different manner, and may include additional or different features as appropriate. Fluid handling system 2 may be deployed via skid equipment, marine vessel deployed or may be comprised of sub-sea deployed equipment.

Turning now to FIG. 2, an example well system 100 for introduction of an embodiment of the treatment fluid comprising a metal sulfide mitigation package described herein into a wellbore 105 is shown. As depicted in FIG. 2, system 100 may include a fluid handling system 110 for introducing an embodiment of the treatment fluid 115 comprising a metal sulfide mitigation package into the wellbore by way of tubular 120. As shown in FIG. 2, the treatment fluid 115 is flowed through wellbore 105 into subterranean formation 130. One embodiment of the treatment fluid 115 may include any metal sulfide mitigation package disclosed herein in any desirable volume and concentration. In the illustrated embodiment, the fluid handling system 110 is above the surface 125 while wellbore 105 and tubular 120 are below the surface 125. The fluid handling system 110 can be configured in any suitable manner to the operation and may include additional or different features as appropriate. The fluid handling system 110 may be deployed via skid equipment, marine vessel deployed or may be comprised of sub-sea deployed equipment.

As illustrated in FIG. 2, wellbore 105 may include vertical and horizontal sections. Generally, a wellbore 105 may include horizontal, vertical, slant, curved, and other types of wellbore geometries and orientations. Wellbore 105 may include a casing that is cemented or otherwise secured to the wellbore wall. Wellbore 105 can be uncased or include uncased sections. Fluid handling system 110 may include mobile vehicles, immobile installations, skids, hoses, tubes, fluid tanks or reservoirs, pumps, valves, and/or other suitable structures and equipment. For example, the fluid handling system 110 may include pumping equipment 135 and a fluid supply 140, which both may be in fluid communication with the tubular 120. The fluid supply 140 may contain a treatment fluid 115 comprising a metal sulfide mitigation package and a base fluid according to one or more embodiments. The pumping equipment 135 may be used to supply the treatment fluid 115 comprising a metal sulfide mitigation package and a base fluid from the fluid supply 140, which may include tank, reservoir, connections to external fluid supplies, and/or other suitable structures and equipment. Pumping equipment 135 may be coupled to tubular 120 to communicate the treatment fluid 115 comprising a metal sulfide mitigation package and a base fluid into wellbore 105. Fluid handling system 110 may also include surface and down-hole sensors to measure pressure, rate, temperature and/or other parameters of the treatment. Fluid handling system 110 may include pump controls and/or other types of controls for starting, stopping and/or otherwise controlling pumping as well as controls for selecting and/or otherwise controlling fluids pumped during the injection treatment. An injection control system may communicate with such equipment to monitor and control the injection treatment.

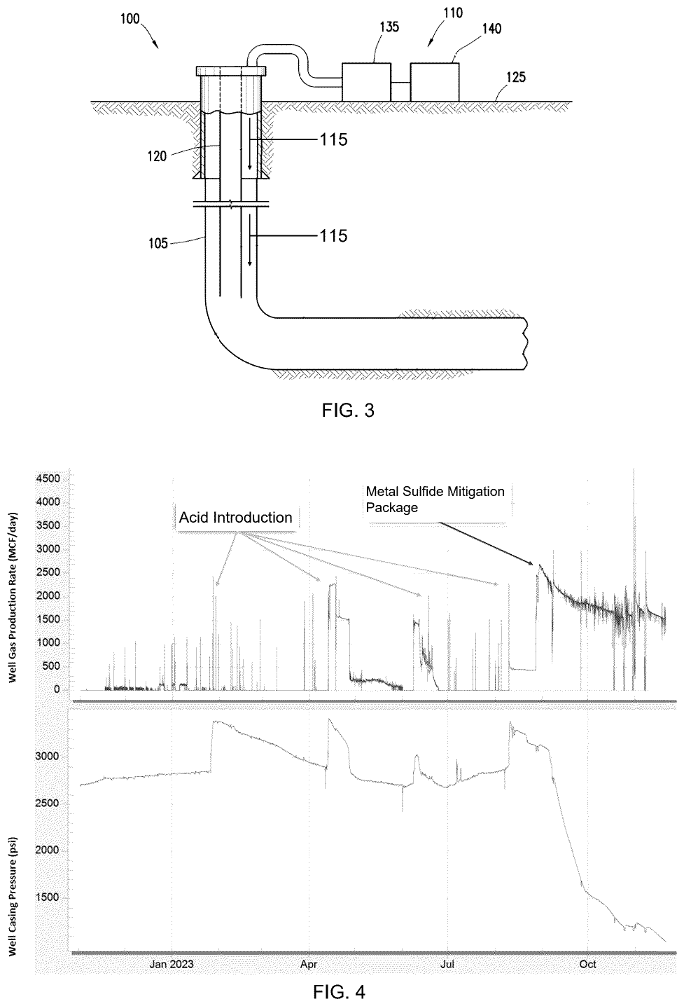

Turning now to FIG. 3, another configuration for example well system 100 is shown. In FIG. 3, the treatment fluid 115 comprising a metal sulfide mitigation package and a base fluid are introduced into wellbore 105 through an annular portion formed between the tubular 120 and wellbore 105.

Accordingly, the present disclosure may provide compositions and methods of removing metal sulfide scale from a wellbore, and particularly methods for removing metal scale deposits with a metal sulfide mitigation package which includes a hydroxysultaine dispersing agent, corrosion inhibitor, and a water-wetting surfactant. The methods and compositions may include any of the various features disclosed herein, including one or more of the following statements.
Statement 1. A method comprising: introducing a metal sulfide mitigation package comprising a hydroxysultaine dispersing agent, a water-wetting surfactant, and a corrosion inhibitor into a wellbore; contacting a metal sulfide scale in the wellbore with the metal sulfide mitigation package; and dissolving at least a portion of the metal sulfide scale with the metal sulfide mitigation package.
Statement 2. The method of statement 1 wherein the hydroxysultaine dispersing agent comprises a hydroxysultaine dispersing agent having a chemical structure according to Structure 1:

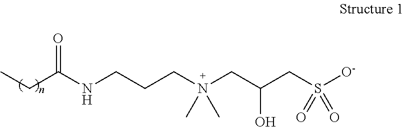

where n is 6, 8, 10, 12, 14, or 16.
Statement 3. The method of statement 2 wherein the hydroxysultaine dispersing agent is present in the metal sulfide mitigation package in an amount about 25 vol. % to about 75 vol. % of the metal sulfide mitigation package.
Statement 4. The method of any of statements 1-3 wherein the water-wetting surfactant comprises a nonylphenol ethoxylate with a chemical structure according to Structure 2:

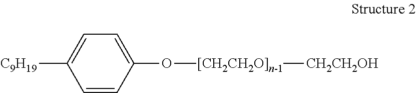

where n is 6, 8, 10, 12, 14, 16, or 18.
Statement 5. The method of any of any of statements 1-4 wherein the water-wetting surfactant is present in the metal sulfide mitigation package in an amount of about 1 vol. % to about 25 vol. % of the metal sulfide mitigation package.
Statement 6. The method of any of statements 1-5 wherein the corrosion inhibitor comprises a benzalkonium chloride with a chemical structure according to Structure 3:

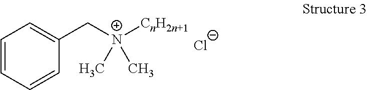

where n is 8, 10, 12, 14, 16, or 18.
Statement 7. The method of any of statements 1-6 wherein the benzalkonium chloride is present in the metal sulfide mitigation package in an amount of about 0.1 vol. % to about 3.0 vol. % of the metal sulfide mitigation package.
Statement 8. The method of any of statements 1-7 wherein the corrosion inhibitor comprises a thioglycolic acid with a chemical structure according to Structure 4:

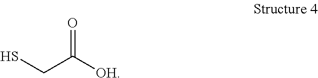

Statement 9. The method of any of statements 1-7 wherein the thioglycolic acid is present in an amount of about 0.1 vol. % to about 3.0 vol. % of the metal sulfide mitigation package.
Statement 10. The method of any of statements 1-8 wherein the corrosion inhibitor comprises soy/DETA imidazoline corrosion inhibitor with a chemical structure according to Structure 5:

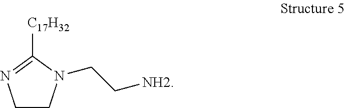

Statement 11. The method of any of statements 1-10 wherein the imidazoline corrosion inhibitor is present in the metal sulfide mitigation package in an amount of about 1 vol. % to about 10 vol. % of the metal sulfide mitigation package.
Statement 12. The method of any of statements 1-11 wherein the metal sulfide mitigation package further comprises an aminoethylethanolamine phosphonate scale inhibitor.
Statement 13. The method of any of statements 1-12 wherein the aminoethylethanolamine phosphonate scale inhibitor is present in the metal sulfide mitigation package in an amount at of about 5 vol. % to about 20 vol. % of the metal sulfide mitigation package.
Statement 14. The method of any of statements 1-13 wherein the metal sulfide mitigation package further comprises a glycol ether and a glycol.
Statement 15. The method of any of statements 1-14 wherein the metal sulfide mitigation package is introduced into the wellbore by an annulus drip, a slip stream, a capillary string, or batch treatments.
Statement 16. The method of any of statements 1-15 wherein the wellbore has a bottom hole static temperature in a range of about 275° F. to about 400° F.
Statement 17. A method comprising: introducing a metal sulfide mitigation package into a wellbore wherein the metal sulfide mitigation package comprises: a hydroxysultaine dispersing agent having a chemical structure according to Structure 1:

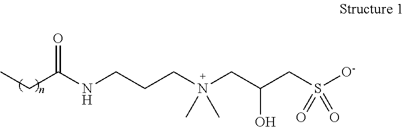

where n is 6, 8, 10, 12, 14, or 16;

a nonylphenol ethoxylate water-wetting surfactant with a chemical structure according to Structure 2:

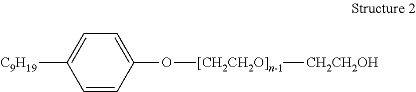

where n is 6, 8, 10, 12, 14, 16, or 18;

a benzalkonium chloride with a chemical structure according to Structure 3:

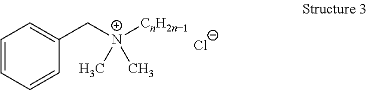

where n is 8, 10, 12, 14, 16, or 18;

thioglycolic acid with a chemical structure according to Structure 4:

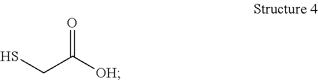

and

a soy/DETA imidazoline corrosion inhibitor with a chemical structure according to

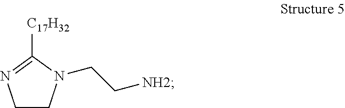

wherein the hydroxysultaine dispersing agent is present in the metal sulfide mitigation package in an amount about 25 vol. % to about 75 vol. %, wherein the nonylphenol ethoxylate water-wetting surfactant is present in the metal sulfide mitigation package in an amount of about 1 vol. % to about 25 vol. % of the metal sulfide mitigation package, wherein the benzalkonium chloride is present in the metal sulfide mitigation package in an amount of about 0.1 vol. % to about 3.0 vol. % of the metal sulfide mitigation package, wherein the thioglycolic acid is present in an amount of about 0.1 vol. % to about 3.0 vol. % of the metal sulfide mitigation package, and wherein the imidazoline corrosion inhibitor is present in the metal sulfide mitigation package in an amount of about 1 vol. % to about 10 vol. % of the metal sulfide mitigation package; contacting a metal sulfide scale in the wellbore with the metal sulfide mitigation package; and dissolving at least a portion of the metal sulfide scale with the metal sulfide mitigation package.
Statement 18. The method of statement 17 wherein the metal sulfide mitigation package is introduced into the wellbore by an annulus drip, a slip stream, a capillary string, or batch treatments.
Statement 19. A metal sulfide mitigation package comprising: a hydroxysultaine dispersing agent having a chemical structure according to Structure 1:

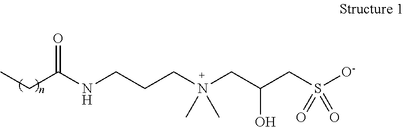

where n is 6, 8, 10, 12, 14, or 16;

a nonylphenol ethoxylate water-wetting surfactant with a chemical structure according to Structure 2:

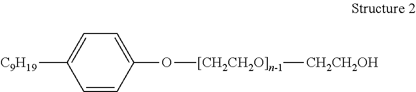

where n is 6, 8, 10, 12, 14, 16, or 18;

a benzalkonium chloride with a chemical structure according to Structure 3:

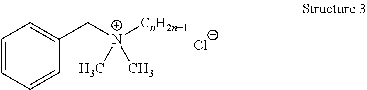

where n is 8, 10, 12, 14, 16, or 18;

thioglycolic acid with a chemical structure according to Structure 4:

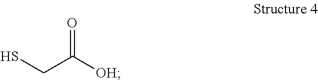

a soy/DETA imidazoline corrosion inhibitor with a chemical structure according to Structure 5:

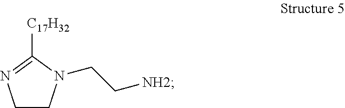

and

a phosphonate scale inhibitor having a chemical structure according to Structure 6:

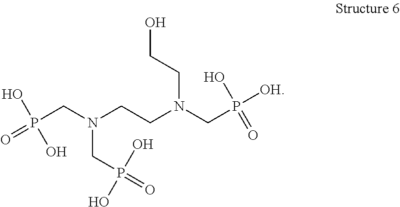 [SMILES: O=P(O)(O)CN(CCO)CCN(CP(=O)(O)O)CP(=O)(O)O]

Statement 20. The metal sulfide mitigation package of statement 19 wherein, wherein the hydroxysultaine dispersing agent is present in the metal sulfide mitigation package in an amount about 25 vol. % to about 75 vol. %, wherein the nonylphenol ethoxylate water-wetting surfactant is present in the metal sulfide mitigation package in an amount of about 1 vol. % to about 25 vol. % of the metal sulfide mitigation package, wherein the benzalkonium chloride is present in the metal sulfide mitigation package in an amount of about 0.1 vol. % to about 3.0 vol. % of the metal sulfide mitigation package, wherein the thioglycolic acid is present in an amount of about 0.1 vol. % to about 3.0 vol. % of the metal sulfide mitigation package, wherein the imidazoline corrosion inhibitor is present in the metal sulfide mitigation package in an amount of about 1 vol. % to about 10 vol. % of the metal sulfide mitigation package, and wherein the aminoethylethanolamine phosphonate scale inhibitor is present in the metal sulfide mitigation package in an amount at of about 5 vol. % to about 20 vol. % of the metal sulfide mitigation package.

To facilitate a better understanding of the present invention, the following examples of certain aspects of some embodiments are given. In no way should the following examples be read to limit, or define, the entire scope of the disclosure.

### EXAMPLES

In this example, a treatment fluid comprising a metal sulfide mitigation package was utilized to treat a gas well which was experiencing rapid FeS plugging. The well was a high temperature gas well with downhole temperatures ranging from 300° F. to 350° F. in the producing zones. Several acid treatment jobs were performed using 15% HCl which caused the production to temporarily improve to about 2000 MCF/day (million cubic feet per day) before rapidly decreasing to 0 MCF/day over the course of 3 to 5 days.

A metal sulfide mitigation package comprising cocamidopropyl hydroxysultaine dispersing agent in an amount of about 50 vol. %, a corrosion inhibitor package including C18 benzalkonium chloride corrosion inhibitor in an amount of about 0.5 vol. %, soy/DETA imidazoline corrosion inhibitor in an amount of about 5 vol. %, and thioglycolic acid corrosion inhibitor in an amount of about 1 vol. %, a nonylphenol ethoxylate water-wetting surfactant, aminoethylethanolamine phosphonate scale inhibitor in an amount of about 10 vol. %, ethylene glycol in an amount of about 9 vol. %, and ethylene glycol monobutyl ether in an amount of about 25 vol. % was prepared and introduced into the wellbore at 750 ppm. FIG. 4 is a graph of gas production and well casing pressure for the wellbore treated with the metal sulfide mitigation package. It was observed that the treatment boosted the gas product and maintained at high levels for at least 5 months since the treatment with continuously decreasing casing pressure. Additional benefits included control corrosion and scale at the same time without causing overtreatment for the low-water producing well due to the foaming function in the metal sulfide mitigation package.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method comprising:
introducing a metal sulfide mitigation package comprising a hydroxysultaine dispersing agent, a water-wetting surfactant, and a corrosion inhibitor into a wellbore;
contacting a metal sulfide scale in the wellbore with the metal sulfide mitigation package; and
dissolving at least a portion of the metal sulfide scale with the metal sulfide mitigation package.

2. The method of claim 1 wherein the hydroxysultaine dispersing agent comprises a chemical structure according to Structure 1: 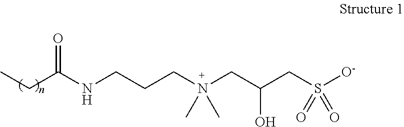
where n is 6, 8, 10, 12, 14, or 16.

3. The method of claim 2 wherein the hydroxysultaine dispersing agent is present in the metal sulfide mitigation package in an amount about 25 vol. % to about 75 vol. % of the metal sulfide mitigation package.

4. The method of claim 1 wherein the water-wetting surfactant comprises a nonylphenol ethoxylate with a chemical structure according to Structure 2: 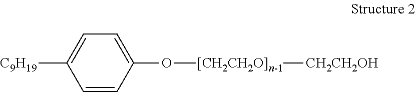
where n is 6, 8, 10, 12, 14, 16, or 18.

5. The method of claim 4 wherein the water-wetting surfactant is present in the metal sulfide mitigation package in an amount of about 1 vol. % to about 25 vol. % of the metal sulfide mitigation package.

6. The method of claim 1 wherein the corrosion inhibitor comprises a benzalkonium chloride with a chemical structure according to Structure 3: 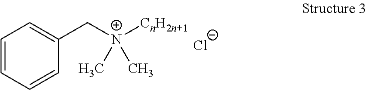
where n is 8, 10, 12, 14, 16, or 18.

7. The method of claim 6 wherein the benzalkonium chloride is present in the metal sulfide mitigation package in an amount of about 0.1 vol. % to about 3.0 vol. % of the metal sulfide mitigation package.

8. The method of claim 1 wherein the corrosion inhibitor comprises a thioglycolic acid with a chemical structure according to Structure 4:

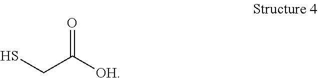

9. The method of claim 8 wherein the thioglycolic acid is present in an amount of about 0.1 vol. % to about 3.0 vol. % of the metal sulfide mitigation package.

10. The method of claim 1 wherein the corrosion inhibitor comprises soy/DETA imidazoline corrosion inhibitor with a chemical structure according to Structure 5:

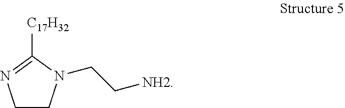

11. The method of claim 10 wherein the imidazoline corrosion inhibitor is present in the metal sulfide mitigation package in an amount of about 1 vol. % to about 10 vol. % of the metal sulfide mitigation package.

12. The method of claim 1 wherein the metal sulfide mitigation package further comprises an aminoethylethanolamine phosphonate scale inhibitor.

13. The method of claim 12 wherein the aminoethylethanolamine phosphonate scale inhibitor is present in the metal sulfide mitigation package in an amount at of about 5 vol. % to about 20 vol. % of the metal sulfide mitigation package.

14. The method of claim 1 wherein the metal sulfide mitigation package further comprises a glycol ether and a glycol.

15. The method of claim 1 wherein the metal sulfide mitigation package is introduced into the wellbore by an annulus drip, a slip stream, a capillary string, or batch treatments.

16. The method of claim 1 wherein the wellbore has a bottom hole static temperature in a range of about 275° F. to about 400° F.

17. A method comprising:
introducing a metal sulfide mitigation package into a wellbore wherein the metal sulfide mitigation package comprises:
a hydroxysultaine dispersing agent having a chemical structure according to Structure 1: 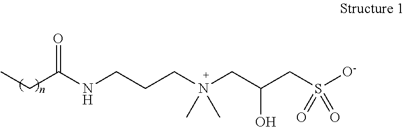
where n is 6, 8, 10, 12, 14, or 16;
a nonylphenol ethoxylate water-wetting surfactant with a chemical structure according to Structure 2: 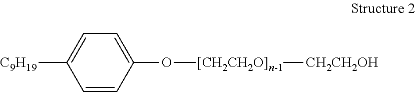
where n is 6, 8, 10, 12, 14, 16, or 18;
a benzalkonium chloride with a chemical structure according to Structure 3: 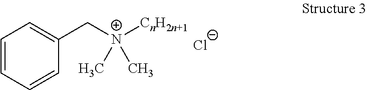
where n is 8, 10, 12, 14, 16, or 18;
thioglycolic acid with a chemical structure according to Structure 4: 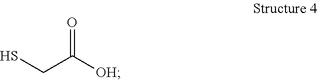
and
a soy/DETA imidazoline corrosion inhibitor with a chemical structure according to Structure 5: 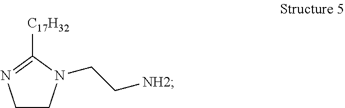
wherein the hydroxysultaine dispersing agent is present in the metal sulfide mitigation package in an amount about 25 vol. % to about 75 vol. %, wherein the nonylphenol ethoxylate water-wetting surfactant is present in the metal sulfide mitigation package in an amount of about 1 vol. % to about 25 vol. % of the metal sulfide mitigation package, wherein the benzalkonium chloride is present in the metal sulfide mitigation package in an amount of about 0.1 vol. % to about 3.0 vol. % of the metal sulfide mitigation package, wherein the thioglycolic acid is present in an amount of about 0.1 vol. % to about 3.0 vol. % of the metal sulfide mitigation package, and wherein the imidazoline corrosion inhibitor is present in the metal sulfide mitigation package in an amount of about 1 vol. % to about 10 vol. % of the metal sulfide mitigation package;
contacting a metal sulfide scale in the wellbore with the metal sulfide mitigation package; and
dissolving at least a portion of the metal sulfide scale with the metal sulfide mitigation package.

18. The method of claim 17 wherein the metal sulfide mitigation package is introduced into the wellbore by an annulus drip, a slip stream, a capillary string, or batch treatments.

19. A metal sulfide mitigation package comprising:
a hydroxysultaine dispersing agent having a chemical structure according to Structure 1: 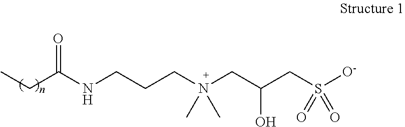
where n is 6, 8, 10, 12, 14, or 16;
a nonylphenol ethoxylate water-wetting surfactant with a chemical structure according to Structure 2: 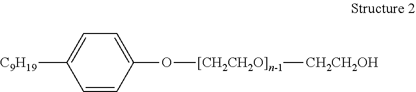
where n is 6, 8, 10, 12, 14, 16, or 18;
a benzalkonium chloride with a chemical structure according to Structure 3: 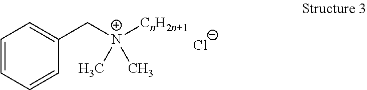
where n is 8, 10, 12, 14, 16, or 18;
thioglycolic acid with a chemical structure according to Structure 4: 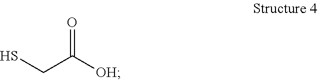
a soy/DETA imidazoline corrosion inhibitor with a chemical structure according to Structure 5: 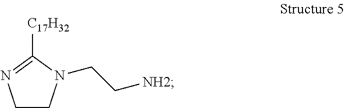
and
a phosphonate scale inhibitor having a chemical structure according to Structure 6:

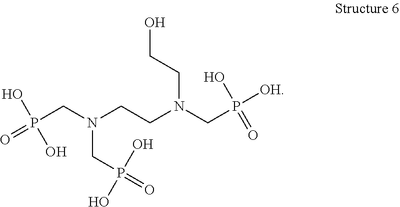 [SMILES: O=P(O)(O)CN(CCO)CCN(CP(=O)(O)O)CP(=O)(O)O]

20. The metal sulfide mitigation package of claim 19 wherein, wherein the hydroxysultaine dispersing agent is present in the metal sulfide mitigation package in an amount about 25 vol. % to about 75 vol. %, wherein the nonylphenol ethoxylate water-wetting surfactant is present in the metal sulfide mitigation package in an amount of about 1 vol. % to about 25 vol. % of the metal sulfide mitigation package, wherein the benzalkonium chloride is present in the metal sulfide mitigation package in an amount of about 0.1 vol. % to about 3.0 vol. % of the metal sulfide mitigation package, wherein the thioglycolic acid is present in an amount of about 0.1 vol. % to about 3.0 vol. % of the metal sulfide mitigation package, wherein the imidazoline corrosion inhibitor is present in the metal sulfide mitigation package in an amount of about 1 vol. % to about 10 vol. % of the metal sulfide mitigation package, and wherein the aminoethylethanolamine phosphonate scale inhibitor is present in the metal sulfide mitigation package in an amount at of about 5 vol. % to about 20 vol. % of the metal sulfide mitigation package.
